(19) United States
(12) Patent Application Publication
(10) Pub. No.: US 2005/0212243 A1
(43) Pub. Date: Sep. 29, 2005

(54) Material handling system

(76) Inventor: Melvin D. Terry, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/079,727

(22) Filed: Mar. 8, 2005

Related U.S. Application Data
(60) Provisional application No. 60/551,536, filed on Mar. 9, 2004.

(51) Int. Cl. B62B 3/04

(52) U.S. Cl. 280/79.11

(57) ABSTRACT

A dolly (102) for supporting a load (106) vertically above a horizontal surface (110) and moving the load upon the horizontal surface. The dolly includes a frame (118) and a load bearing member (114) for supporting the load. The load bearing member is pivotally coupled to the frame. The dolly further includes a wheel assembly (108) coupled to the frame for permitting the dolly to roll upon the horizontal surface.

### CROSS-REFERENCE TO RELATED APPLICATION

This application claims the benefit of U.S. Provisional Application No. 60/551,536, filed Mar. 9, 2004, the disclosure of which is hereby expressly incorporated by reference.

### FIELD OF THE INVENTION

This invention relates to material handling systems for supporting a load during transport and, more particularly to material handling systems having a plurality of wheeled modules for supporting the load in a manner that allows irregularities of a supporting surface to be absorbed and balanced by the wheeled modules.

### BACKGROUND OF THE INVENTION

The manufacture and/or assembly of extremely large and often delicate objects becomes difficult in that they must often be transported during manufacture as well as taken from the place of manufacture for inspection, modification and eventually for use in areas where conventional overhead cranes of sufficient capacity are not available or practical because of space requirements. It is desirous that these objects often must be transported without the wheels causing overloading of the floors from floor undulations or causing torquing or otherwise stressing the object. In the past, heavy solid suspension trailers and special heavy roller equipment has been manufactured for this transport on an individual customized basis or, as an alternative, a special smooth and level supporting floor or surface has been prepared, allowing the transportation by air bearings (air cushion devices) or the like. It becomes immediately obvious that the movement of devices upon specifically and individually constructed support vehicles as well as devices which require a specially prepared underlayment are normally time consuming, expensive and quite often impractical for many types of industrial applications. Thus there exists a need for a more universal approach.

One attempt to fulfill this need is disclosed in U.S. Pat. No. 5,379,842 issued to M. Terry (hereinafter “Terry”), the disclosure of which is hereby expressly incorporated by reference. Terry teaches a material handling system using a plurality of dollies for supporting a load during transport. The dollies include a load bearing platform for supporting a load, a frame, and a plurality of wheel assemblies. In Terry, the load bearing platform is rigidly coupled to the frame and is therefore, not able to move relative to the frame. Further, each wheel assembly must be individually biased relative to the frame and the load bearing platform, increasing the cost of the material handling system.

Although effective, the material handling system disclosed in Terry is not without problems. For instance, the load bearing platform is supported by eight wheel assemblies, each wheel assembly requiring its own biasing system for individually biasing the wheel assembly relative to the frame and the load bearing platform so that the wheel assembly can move vertically relative to the load bearing platform and the frame, thereby increasing the cost and complexity of the material handling system. Further, the load bearing platform is rigidly coupled to the frame such that load bearing platform is not able to pivot relative to the frame of the dolly to assist in accommodating surface irregularities or move vertically relative to the frame. Thus, there exists a need for a relative inexpensive material handling system that is better able to accommodate surface irregularities in capacity ranges above that currently practical with existing machinery moving equipment.

Further, there exist a need for a material handling system which permits the movement of objects without the need for underlayment and without the need for specifically constructing the system to accommodate a specific type of object. Further, there exists a need for a material handling system wherein the load bearing platform may pivot about a vertical axis such that a greater range of irregularities of the supporting surface may be absorbed and balanced by the wheel modules. Further still, there exists a need for a material handling system that will reduce floor damage, where large numbers of supporting axle assemblies are manually steerable under full load, and which has force equalizing suspension for compliance over irregular surfaces.

### SUMMARY OF THE INVENTION

One embodiment of a dolly formed in accordance with the present invention for supporting a load vertically above a horizontal surface and moving the load upon the horizontal surface is disclosed. The dolly includes a frame and a load bearing member for supporting the load. The load bearing member is pivotally coupled to the frame. The dolly further includes a wheel assembly coupled to the frame for permitting the dolly to roll upon the horizontal surface.

Another embodiment of a dolly formed in accordance with the present invention for supporting a load above a surface and moving the load upon the surface is disclosed. The dolly includes a frame and a load bearing member for supporting the load, the load bearing member coupled to the frame to have two or more degrees of freedom relative to the frame. The dolly includes a first, second, and third wheel assembly, each coupled to the frame for permitting the dolly to roll upon the surface. The first, second, and third wheel assemblies support the frame in a three point suspension above the surface.

Still another embodiment of a dolly formed in accordance with the present invention for supporting a load vertically above a substantially horizontal surface and moving the load upon the surface is disclosed. The dolly includes a frame and a load bearing member pivotally coupled to the frame for supporting the load. The dolly further includes a biasing member for moveably supporting the load bearing member relative to the frame and biasing the load bearing member toward the load. The dolly also includes a wheel assembly coupled to the frame for permitting the dolly to roll upon the surface.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a perspective view of one embodiment of a material handling system formed in accordance with the present invention, the material handling system including a plurality of dollies disposed under a load to aid in the transport of the load, the load being moved by a forklift;

FIG. 2 is a top planar view of one of the dollies of the material handling system of FIG. 1 wherein the axles of the dolly have been oriented parallel to one another for clarity;

FIG. 3 is a partial cross-sectional view of the dolly of FIG. 2, wherein the axles have been rotated 90 degrees from the orientation of the axles depicted in FIG. 2;

FIG. 4 is a top planar view of the material handling system disposed beneath the load of FIG. 1;

FIG. 5 is a partial cross-sectional view of an alternate embodiment of a dolly formed in accordance with the present invention and suitable for use with the material handling system of FIG. 1 with the dolly shown supporting a load on a horizontal surface; and

FIG. 6 is the dolly of FIG. 5 illustrated with the dolly supporting the load on an irregular horizontal surface.

### DETAILED DESCRIPTION OF THE PREFERRED EMBODIMENT

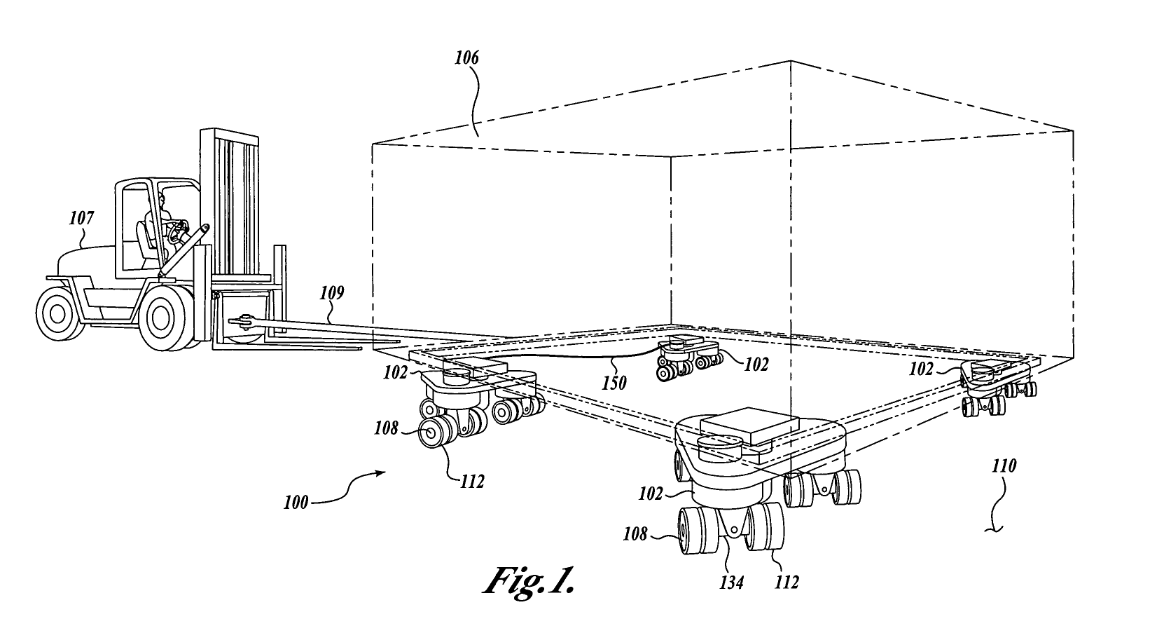

One embodiment of a material handling system 100 formed in accordance with the present invention is illustrated and described with respect to FIGS. 1-4. Referring to FIG. 1, the material handling system 100 includes a plurality of wheeled modules or dollies 102 disposed underneath a load 106, for instance a large load exceeding a predetermined amount, such as 20, 40, or 60 tons. The dollies 102 each include wheel assemblies 108 which support the load 106 and permit the load 106 to be rolled upon a support surface 110, such as a horizontal support surface. For the purposes of this detailed description, a horizontal support surface includes perfectly horizontal surfaces, surfaces having irregularities in them and/or surfaces which are inclined, such as when the material handling system 100 is used to transport a load down a ramp or other inclined surface. The dollies 102 have load distributing properties permitting the load to be evenly distributed between the dollies 102 despite support surface irregularities. Further, the axles 134 of the wheel assemblies 108 also have load distributing properties permitting the load to be evenly distributed between each of the wheels 112 of the wheel assemblies 108 despite support surface irregularities. Each axle 134 of the wheel assemblies 108 may be individually rotated to a selected angular orientation to permit the load to be swung through a turn of a predetermined radius or moved in any selected linear direction.

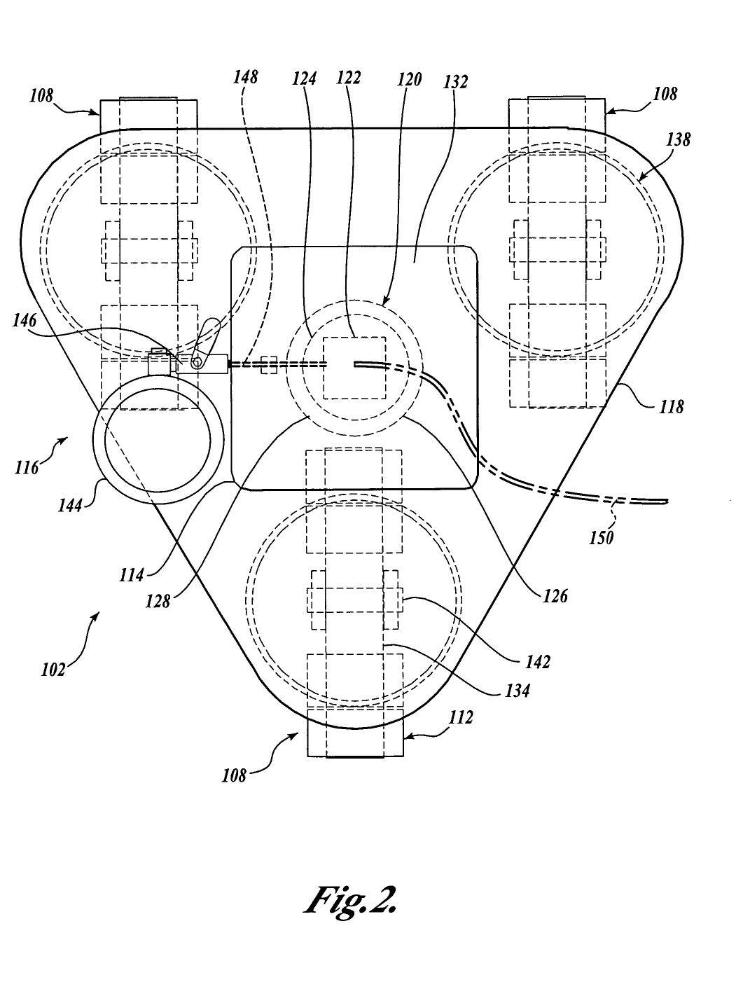

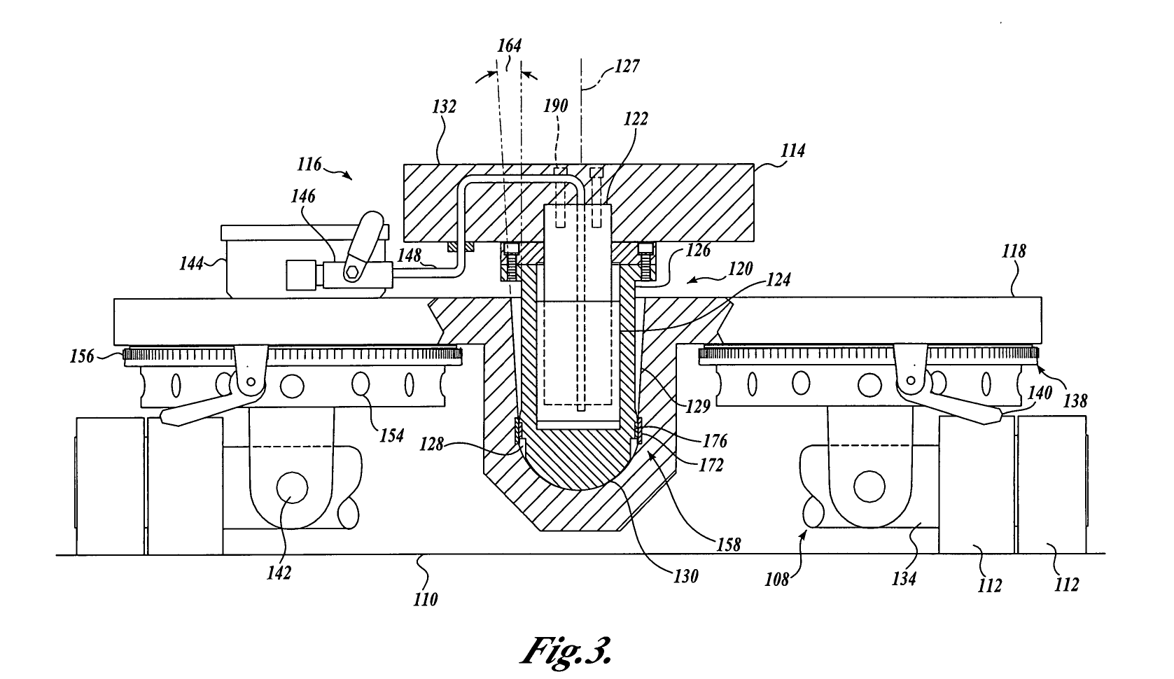

In light of the above general description of the material handling system 100 and focusing now in more detail upon the structure of the material handling system 100, one of the dollies 102 will be described in greater detail with reference to FIGS. 2 and 3. The dolly 102 includes a load bearing member or platform 114, a load balancing system 116, a frame 118, and three wheel assemblies 108.

The load bearing platform 114 of the illustrated embodiment is square shaped and is designed to engage and support the load 106 (see FIG. 1). As should be apparent to those skilled in the art, the load bearing platform 114 can take many suitable forms other than the illustrated form, including specially designed load bearing platforms designed to interface and support a specific load. Preferably, the load bearing platform 114 would have a high-friction, non-skid top surface 132.

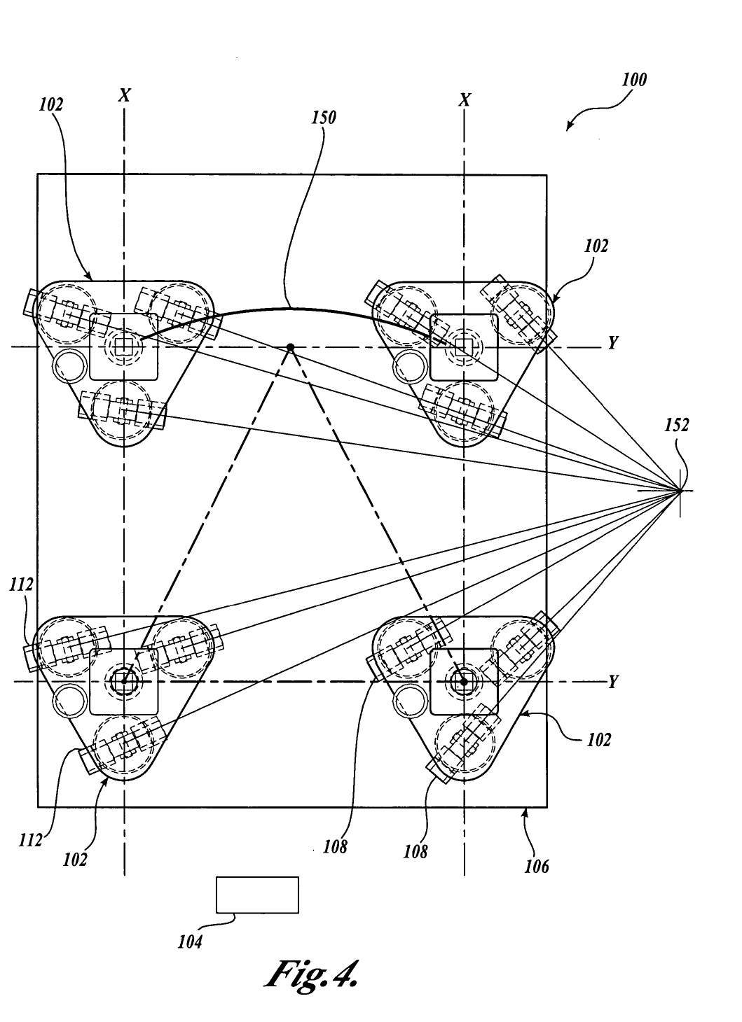

The load balancing system 116 includes any suitable system operable to aid in balancing the portion of the load supported between two or more dollies 102. In the illustrated embodiment, the load balancing system 116 (as best seen in FIG. 4) utilizes a pair of fluid or hydraulic pistons 120 coupled in fluid communication with each other such that if one hydraulic piston extends, the other retracts an equal amount. The hydraulic pistons 120 are disposed in different dollies 102 such that the load supported by the pair of dollies is automatically equalized between the dollies such that each dolly supports an equal amount of the load. The hydraulic pistons 120 act as biasing members for biasing the load bearing platform 114 toward the load, along a substantially vertical axis. Alternately, the load balancing system 116 may include three dollies that are solid with no suspension and a fourth that has a suspension or biasing member, such as a fluid cylinder, one suitable example being a pneumatic (nitrogen) cylinder. Preferably, the biasing device may be adjusted according to the loading condition.

Turning to FIG. 3 and focusing on the hydraulic piston or biasing member, the hydraulic piston 120 includes a well known ram 122 and cylinder 124. Hydraulic fluid may be added and removed from the cylinder 124 to effect movement of the ram 122 within the cylinder 124 between an extended position and a retracted position. The distal end of the ram 122 is coupled to the load bearing platform 114 by any suitable means, a few examples being via fasteners 190 or a splined, keyed, or compression fit coupling means. In the illustrated embodiment, the ram 122 is square in cross-section to impede rotation of the ram 122 relative to the cylinder 124, and thus impede rotation of the load bearing platform 114 relative to the frame 118. The hydraulic piston 120 is mounted within a support stem 126. As will be described in further detail below, the support stem 126 is pivotally coupled to the frame 118 such that the load bearing platform 114 may pivot relative to the frame 118 to aid in accommodating irregularities in the support surface 110.

The frame 118 is a rigid structure permitting the mounting of the structures of the material handling system thereto. The frame 118 of the illustrated embodiment is substantially triangular in shape, however it should be apparent to those skilled in the art that other shapes and configurations are suitable for use with and are within the spirit and scope of the present invention. The frame 118 includes a cavity 128 for housing the support stem 126. The cavity 128 includes a load transfer surface 130 upon which the support stem 126 pivots upon, and wherein the load borne by the support stem 126 is transferred to the frame 118, such as through a ball and socket connection. The load transfer surface 130 is preferably located equidistant from the center of each axle 134 of the dolly 102 such that each wheel assembly 108 supports an equal portion of the load supported by dolly 102 in a three point suspension manner.

Preferably, the cavity 128 is configured to position the load transfer surface 130 as low as possible, such that the load transfer surface 130 is in close proximity to the support surface 110, and more importantly, as near as practical to the height of the axles 134 of the wheel assemblies 108. For instance, the bottom most portion of the load transfer surface 130 may be located within about 6 inches, 5 inches, 4 inches, 3 inches, or 2 inches or less from the support surface 110, or which has a height that is within 6 inches, 5 inches, 4 inches, 3 inches, or 2 inches or less of the average height of the axles 134 above the support surface. In one working embodiment, the bottom most portion of the load transfer surface 130 is preferably located at an elevation above the support surface 110 that is less than a height of a top of one of the wheels 112 of the wheel assemblies 108. In another embodiment, the elevation of the bottom most portion of the load transfer surface 130 is within about 3 inches, 2 inches, or 1 inch of the elevation of a center axis of the axles 134 of the wheel assemblies 108, and preferably is substantially at the same elevation as the elevation of the center axis of the axles 134 of the wheel assemblies 108.

This detailed description will now focus upon the wheel assemblies 108. Inasmuch as the wheel assemblies 108 are identical to one another, only one will be described herein for the sake of brevity. Each wheel assembly 108 includes an axle 134 which may be independently angularly rotated in a horizontal plane about a first axis, such as a vertical axis, and pivoted in a vertical plane about a second axis, such as a horizontal axis, oriented perpendicular to the first axis. Disposed on each end of the axle 134 is a pair of wheels 112. Each wheel 112 is independently and rotatably coupled to the axle 134. A pair of wheels 112 are used at the ends of the axle 134 instead of one wide wheel to permit the wheels 112 to spin at different speeds, thereby reducing skidding or scrubbing of portions of the wheels 112 during turning. The wheels 112 may be made from any suitable material, one example being urethane. In one working embodiment, the wheels 112 are 4 inch diameter urethane wheels rated to 3,000 pounds, mounted on 13 inch axles.

Each of the axles 134 is coupled to a rotary plate assembly 138 that can be turned in a horizontal plane about a vertical axis to any desired direction of travel and clamped at the required angle by a suitable clamp 140. Further, the axle 134 is pivotally coupled to the frame 118 such that the axle 134 may pivot about a pivot 142 disposed equidistant between the wheels 112. The axles 134 may pivot in a vertical plane about a horizontal axis passing through the pivot 142 to accommodate irregularities in the support surface 110. Since each of the dollies 102 has three articulating axles 134, the load is equally distributed over all twelve wheels 112, regardless of irregularities in the support surface 110 in a three point suspension manner.

The dolly 102 may also include an oil reservoir 144. The oil reservoir 144, as its name implies, stores oil for use in the hydraulic piston 120. A valve 146 disposed in a hydraulic line 148 controls the flow of hydraulic oil between the oil reservoir 144 and the hydraulic piston 120. An interconnecting hydraulic line 150 (See FIG. 4) may be connected between two cylinders 124 of two separate dollies 102. By tying the cylinders 124 to one another via the interconnecting hydraulic line 150, hydraulic fluid is permitted to flow freely back and forth between the cylinders 124 to balance the load between the cylinders 124. This aids in forming a fully equalizing three-point suspension of the load using four dollies 102 as will be discussed in greater detail below.

Still referring to FIG. 3, as stated above, the support stem 126 is pivotally coupled to the frame 118 such that the load bearing platform 114 may pivot relative to the frame 118 to aid in accommodating irregularities in the support surface 110. Moreover, the support stem 126 sits in a ball shaped socket that permits the frame 118 to tilt about 0 to 4 degrees 154 in any direction. This is accomplished through a coupling system 158. The coupling system 158 further prevents the support stem 126 from rotating such that the frame 118 and wheels 112 do not become miss-aligned, i.e., become angularly displaced relative to the load bearing platform 114. The coupling system 158 permits the support stem 126 to pivot in any direction away from a predetermined axis, such as an axis located perpendicular to the frame 118, or a vertical axis, while impeding rotation of the support stem 126 about the predetermined axis 127.

Moreover, the coupling system 158 permits the support stem 126 to pivot so as to be angularly displaced from the predetermined axis 127 while impeding rotation of the support stem 126 about the predetermined axis 127. The cavity 128 is shaped to provide a mechanical limit stop 129 to limit the angular displacement of the support stem 126 to a maximum of about 3 degrees relative to the predetermined axis 127, although it should be apparent that other maximum angular displacements 164 are within the spirit and scope of the present invention.

The coupling system 158 includes spherically cut splines 172 coupled to the cavity 128 which interface with correspondingly shaped straight cut splines 176 coupled to the support stem 126. The splines interact with each other to impede the rotation of the support stem 126 about the vertical axis, while still permitting the support stem 126 to be angularly displaced from the predetermined axis 127 a preselected amount 164. Preferably, the splines are spherically cut to permit the support stem 126 pivot freely about the vertical axis without binding.

Thus, it can be seen that the coupling system 158, in combination with the balancing system 116, permits the load bearing platform 114 to move in three degrees of freedom relative to the frame 118. Moreover, the position of the vertically moveable load bearing platform 114 is defined by its elevation relative to the floor as determined by whether the hydraulic piston 120 is in an extended or retracted position (a first degree of freedom), the angular displacement 164 of the support stem 126 relative to the predetermined axis 127, typically 0 to 4 degrees (a second degree of freedom), and the angle, measured in a substantially horizontal plane, in which the support stem 126 is tilting toward, such as 0 to 360 degrees (a third degree of freedom).

Referring to FIG. 4, the material handling system 100 further includes a computational device 104. The computational device 104 is a unit that is capable of accepting user inputs and calculating steering geometry based upon the inputs, a few suitable examples being a computer, a calculator, and a Personal Digital Assistant (PDA). In the illustrated embodiment, the computational device 104 utilizes a laptop computer display and keyboard. The display is a touch screen with a graphic display used in conjunction with a numeric keypad and some function keys. As will be described in further detail below, the computational device 104 is able to accept user input regarding the positions of the dollies 102 under the load 106 and information regarding a user's desire to change the direction of the movement of the load 106. From this information, the computational device 104 is able to calculate the appropriate angle of each of the axles 134 to accomplish the desired course change. With the desired angle of turn, steering mode chosen, or a distance of a specific center point of a turn from a center location of the material handling system 100, the computational device 104 may provide angular wheel positions to accomplish the desired course change.

Referring to FIG. 1, in light of the above description of the components of the material handling system 100, the operation of the material handling system 100 will now be described. Ideally, loads 106 are supported by a three point support system such that irregularities in the support surface 110 can be accommodated. However, rigging loads are generally rectangular making it unfeasible to count on operating on just three dollies 102. Thus, the illustrated material handling system 100 interconnects two of the four dollies 102 such that the interconnected dollies 102 share one end of the load to gain three point suspension. The material handling system 100 utilizes the balancing system 116 to share the load between two dollies 102. More specifically, the interconnected cylinders 124 are filled half full of oil, and are connected to each other by the interconnecting hydraulic line 150. As the dollies 102 travel across the support surface 110, the dollies will share the load equally even as the load is carried over an undulating surface, across floor drains, ramps, and other irregular surface conditions.

It should be apparent to those skilled in the art that for larger loads, where it is desirable to use a larger number of supporting dollies, that fully equalizing suspension can be achieved across the total number of dollies by dividing them into three groups. The dollies in each group can have interconnecting fluid lines, thereby forming a three-point suspension under a moving load with an unlimited number of dollies. All of the steering functionality described herein is fully applicable to a larger pluralities of dollies.

Referring to FIG. 3, to accomplish load balancing between dollies 102, the cylinders 124 are coupled to a fluid reservoir 144 via the hydraulic line 148. Assuming the rams 122 are at rest at the bottom of their stroke, the valve 146 to the reservoir 144 is opened and one of the load bearing platforms 114 is raised manually, sucking oil from the fluid reservoir 144 to fill the cylinder 124 coupled to the load bearing platform 114. When the cylinder 124 reaches the top of its stroke, the valve 146 to the reservoir 144 is closed, isolating the pair of cylinders 124 in a closed loop circuit. Pressing the load bearing platform 114 of one of the cylinders 124 will cause the load bearing platform 114 of the interconnected dolly 102 to rise. The two cylinders 124 thus operate as a single mechanism, and the point of load carrying is the mid-point on a centerline drawn halfway between the two dollies 102, thus creating a three point suspension system.

Turning to FIG. 4, to prepare for insertion of the dollies 102 under the load 106, the load bearing platforms 114 are adjusted in height to be at approximately the midpoint of the ram travel. The dollies 102 are rolled under the load, which has been jacked up in the air and cribbed at the proper height to accept the dollies 102. In one method of dolly insertion, rollers or retracting caster wheels are used to roll the dollies under the load 106 and to position them accurately and parallel in the X and Y axes. In another method of dolly insertion, small air bearings are slipped under the dolly 102 and inflated just enough to relieve the weight and provide the near effortless omni-directional movement needed to position the dollies. The needed smooth floor condition for the air bearings is assured in difficult areas with the use of thick poly-coated (milk-carton) paper stock, pealed from standard width rolls (as they are obtained from paper suppliers to the dairy industry). The inexpensive strips can be reused or discarded.

The dollies 102 are positioned so that the X and Y centerline planes are perpendicular to each other. The separation distance between the two X centerlines and the two Y centerlines may be any selected distance. The separation distances between the two X centerlines and the two Y centerlines is measured to preferably within +/−⅛^{th} inch, and more preferably within +/− 1/16^{th} inch. Laser alignment and measuring tools may be used to accurately place the dollies 102. Once the dollies 102 are positioned, the load 106 is then lowered onto the dollies 102.

Alternately, a physical alignment tool may be used by the user to accurately place the dollies under the load 106. For instance, the user (the rigger or machinery moving crew members) may prefabricate one or more rectangular frames that attach to the load bearing platforms 114 of each dolly, interconnecting all of the dollies for establishing a fixed measurement and axial perpendicular alignment to the X and Y axes of the dollies 102 beneath the load 106. Such frames need only have an alignment function, not necessarily a load carrying function.

During movement, all of the axles 134 are either aligned so as to be parallel with one another and perpendicular to the direction of travel (for straight travel) or will point to a single center point of rotation 152. The distance to the center point 152 is determined by the degree of turning radius desired and the center distance between the two centerlines that are perpendicular to the direction of travel. By selectively rotating the axles 134, the material handling system 100 may move objects in straight paths, curved paths, laterally, in an oblique direction, and/or rotationally relative to its center or any center point in space.

Still referring to FIG. 4, the material handling system 100 is shown as the load 106 is being transported along an arc about a single center point of rotation 152. It is apparent that each of the axles 134 is oriented at a different angle such that the centerline of each axle 134 aligns with a line extending radially outward from the center point 152. The complexity of the determination of the appropriate angle for each axle 134 is great due to the infinitely variable distances between the X and Y centerlines and the infinitely variable desired radius of turn. The angularity will vary greatly for every application. The needed accuracy of the angles is not generally obtainable by estimation. The angles are as infinitely variable as are the distances between X or Y axes and the length of the turning radius. Thus, the computational device 104 is used to precisely calculate the appropriate angle that each axle 134 must be set to accomplish the desired course correction.

The operation of the computational device 104 will now be described. The center distances between the X and Y centerlines is measured and entered into boxes in the touch screen graphic display of the computational device 104. The graphic display may have boxes marked “Turning Radius,” “Separation Distance Between Y Centerlines,” and “Separation Distance Between X Centerlines.” A user would simply enter a dimension in one or the other of the boxes (depending on longitudinal or lateral travel). The supervisor or designated person with the computational device 104 would then enter a dimension from the center of the load to the desired center point 152 (turning radius). The computational device 104 would immediately calculate all of the required geometry and produce an angle setting number on the screen for each axle 134. As should be apparent to those skilled in the art, the computational device 104 and screen display can be made to accommodate any number of dollies 102, including a quantity of dollies exceeding four or less than four.

Referring to FIG. 3, with the load 106 solidly secured to a towing or push vehicle 107 (See FIG. 1) of sufficient weight and capacity to control the load for the particular operating condition, the rigging crew would loosen the locking clamps 140 on each rotary plate assembly 138. The housing of the rotary plate assembly 138 is preferably large as possible in diameter and has a plurality of horizontally oriented apertures 154 disposed in the outer periphery of the rotary plate assembly 138 for insertion of a tip of a hardened bar that can provide the necessary turning leverage. The housing of the rotary plate assembly 138 is preferably marked in degrees, like a protractor. Each axle 134 is then rotated to the specified angle designated by the computational device 104 and locked in place by the locking clamps 140. In the illustrated embodiment, the axles 134 are rotatable about their center point, thereby assisting the rotation of the axles 134 while under full load, eliminating the need to jack up the load 106 during axle reorientation maneuvers.

The load 106 would move in the new direction until the amount of desired turn is accomplished, then be stopped for a new angular adjustment-either back to straight or adjusted to some other radius—say to accomplish an “S” turn—or lateral, oblique, or rotational travel.

In previously developed systems, the riggers would have to jack up the load 106 each time they wanted to adjust or reposition their roller assemblies. In a turning sequence, since all wheels are pointing straight, they can only position them to move a very short distance before the misaligned torsional moment forces on the rollers become too great, and they have to reposition all of the rollers. It is a slow and laborious operation.

With the illustrated embodiment of the material handling system 100, a user can make a full 90 degree, or even a 360 degree turn without having to manually reposition the dollies 102 or adjust axle 134 orientations. Since all of the wheels 136 are equally loaded and rotate on center when rotated for a new travel direction, this repositioning does not require the load 106 to be lifted. Once the cam locking clamps 140 are released, a rigger inserts a bar (not shown) in regularly spaced holes 154 around the rotary plate assemblies 138. Each of the rotary plate assemblies 138 have a protractor scale 156 with the degrees clearly and legibly marked thereon. Each axle 134 is turned to a predetermined and specified direction, then clamped in the selected direction by the clamps 140.

The tow or push vehicle 107 (See FIG. 1) is coupled to the load 106 to provide a force to move the load 106. Preferably, the tow or push vehicle 107 is coupled by a rigid link 109 pivotally coupled at one end to the load 106 and, if needed, a second vehicle may be coupled to the load to assist the towing or pushing of the vehicle. Although the use of a tow or push vehicle 107 is illustrated and described, it should be apparent to those skilled in the art that the dollies 102 may also be self-powered, thereby eliminating the need for a tow or push vehicle 107, without departing from the spirit and scope of the present invention.

Thus, as can be seen, the present invention provides a relatively simple, yet reliable, means for transporting large, heavy and sometimes fragile loads by balancing the individual wheel set load, therefore accommodating an uneven supporting surface and providing equalized loading onto the floor surface to avoid damage to the floor during transport of the load.

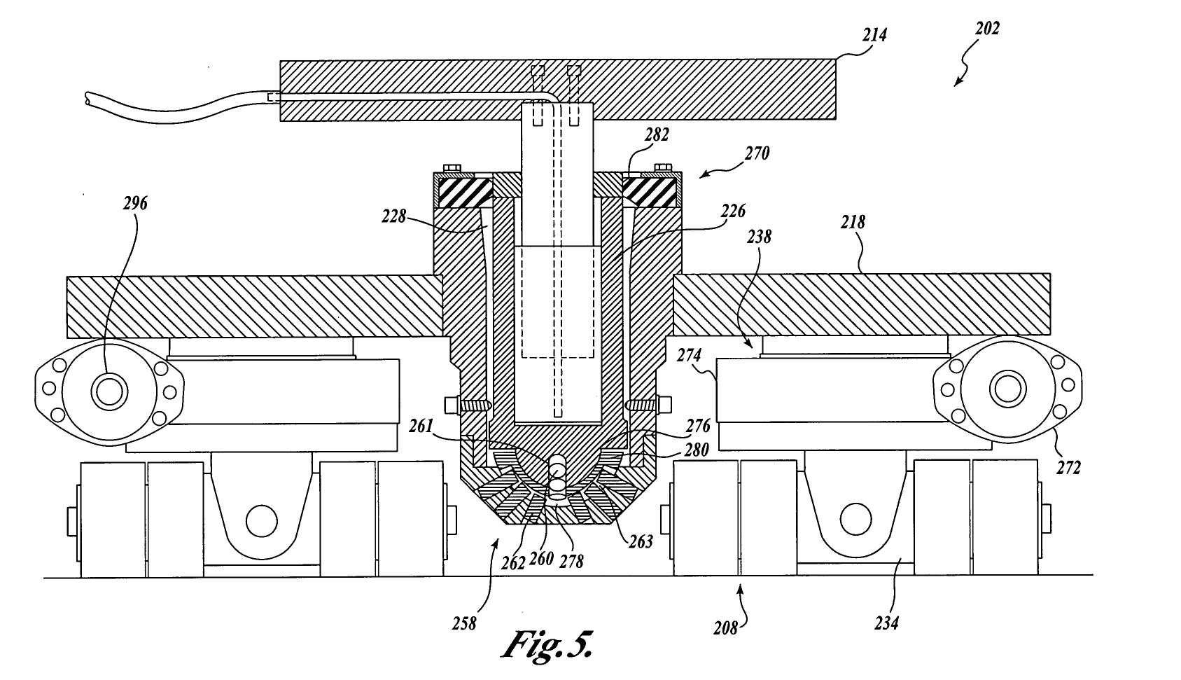

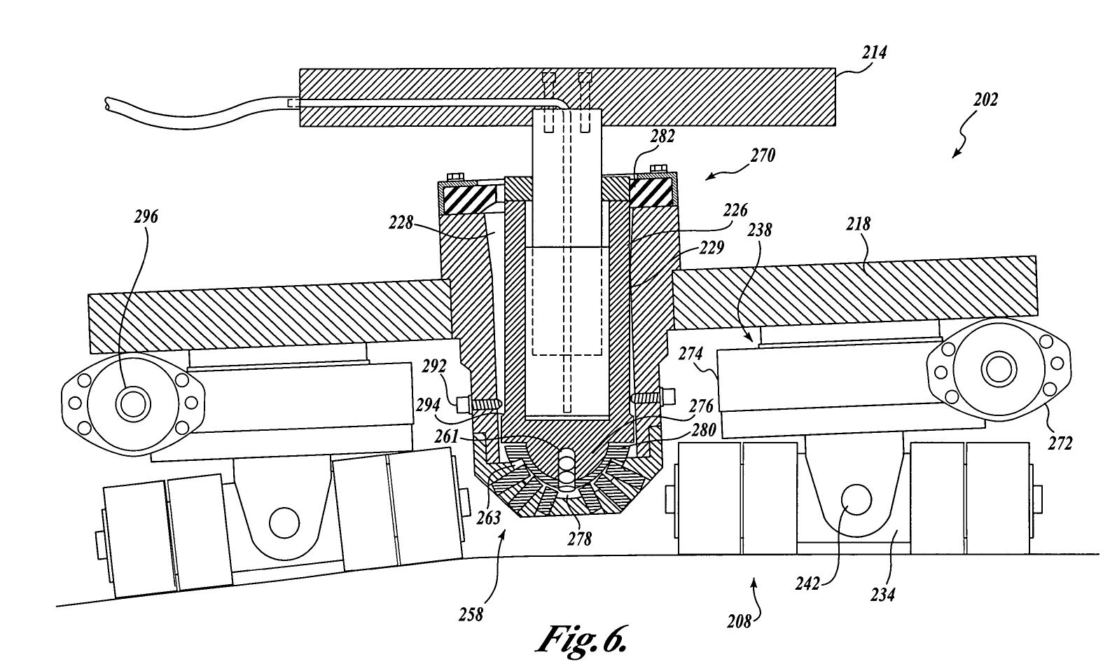

Referring to FIGS. 5 and 6, an alternate embodiment of a dolly 202 formed in accordance with the present invention is shown. The dolly 202 is substantially similar to the dollies 102 of FIGS. 1-4 in construction and operation, and is suitable for use with the material handling system 100 described above. Due to the similarities between the dolly 202 of FIGS. 5 and 6 and those dollies previously described, for the sake of brevity, this detailed description will focus only upon where the construction and/or operation of the dolly 202 deviates from that described above. Moreover, the dolly 202 of FIGS. 5 and 6 is substantially similar to the dolly 102 shown and described above with exception of the rotary plate assembly 238, the coupling assembly 258, and the addition of a piston centering assembly 270. Accordingly, each of these three assemblies will be described in detail below.

The rotary plate assembly 238 of the dolly 202 of FIGS. 5 and 6 is driven by automatic means, which is in stark contrast to the rotary plate assembly 128 of the dolly 102 of FIGS. 1-4, which is manually operated. Moreover, the rotary plate assembly 238 of the dolly 202 of FIGS. 5 and 6 is turned by a worm driven slewing gear or similar drive assembly 272 which is able to selectively rotate the rotary plate assembly 238 to a selected angular displacement. Preferably the selected angular displacement is selected by the computational device 104 (See FIG. 4). The user then actuates the drive assembly 272 by either manually driving a force transfer member, such as a splined socket 296 as shown, or driving the force transfer member via a portable power unit, to selectively rotate the rotary plate assembly 238 and associated axles 234 to the selected angular orientation.

Moreover, in the illustrated embodiment, the splined socket 296 of the drive assembly 272 is rotated by the user to selectively rotate a worm gear that in turn drives a slew bearing 274 associated with the rotary plate assembly 238. Using the non-overhauling characteristics of the worm drive assembly 272, the need for a locking device is eliminated and allows an operator to adjust the angular orientation of the wheel assemblies 208 in an expedited manner, with less labor, and from a more advantageous position.

The coupling assembly 258 of the alternate embodiment of the dolly 202 will now be described in detail. The coupling assembly 258 provides a gimbaled connection of the support stem 226 to the frame 218, such that the support stem 226 may be angularly displaced from a predetermined axis, such as a vertical axis, in any direction, while being restrained from rotating about the predetermined axis. The coupling assembly 258 is of a gimbaled ball and double socket arrangement, having a ball 276 received within a socket 278, with a sleeve 280 slidably disposed between the ball 276 and the socket 278. An elongated slot 261 is disposed in the ball 276 and acts as a race way, or guide slot, for receiving one or more dowels or shaft-mounted roller bearings 260 coupled to the sleeve 280. The roller bearings 260 restrict the ball 276 to rotating in a vertically oriented plane aligned with the elongated slot 261.

The sleeve 280 has an elongate slot 263 disposed on an outer surface of the sleeve 280, the elongate slot 263 oriented perpendicular to the slot 261 of the ball 276. One or more roller bearings or hardened dowel pins 262 coupled to the socket 278 ride within the elongate slot 263, thereby restricting the sleeve 280 to rotating in a vertically oriented plane aligned with the elongate slot 263. Thus, with this arrangement, the ball 276 can only move in the direction of the elongate slot 261 in the sleeve 280, and the sleeve 280 in turn can only move in the direction of the elongate slot 263 in the socket 278. However, in combination, the movement of the ball 276 within the elongate slot 261 of the sleeve 280 and the movement of the sleeve 280 in the direction of the elongate slot 263 of the socket 278 provides the ability of the support stem 226 to be angularly displaced from the predetermined axis in all directions, while restricting rotation of the support stem 226 about the predetermined axis.

The piston centering assembly 270 includes a biasing device 282 for biasing the support stem 226 in an upright, vertically centered position. The biasing device 282 in the illustrated embodiment is a rubber snubber, although it should be apparent to those skilled in the art that other biasing members are suitable for use with and are within the spirit and scope of the present invention. The biasing device 282 is disposed at the top of the cavity 228 and encircles the support stem 226. An inner diameter of the biasing device 282 is selected to normally engage the support stem 226 and bias the support stem 226 to its upright, vertically centered position.

The initial alignment of the four dollies 202 under the load is aided by use of the piston centering assembly 270. Moreover, it is has been determined that when the dollies 202 are being positioned, accurate placement and alignment of the dollies 202 is facilitated by having the support stem 226 in a straight up, non-tilted position. The perpendicular surface of the load bearing platform 214 should be centered about the support stem 226 when the load is lowered onto the dollies 202. The biasing member 282 holds the unloaded support stem 226 centered during lowering of the load upon the dollies 202. During use, the biasing member 282 compresses and allows the support stem 226 to pivot so as to be angularly displaced from the predetermined axis.

Moreover, referring to FIG. 6, the dolly 202 is shown supporting the load upon an irregular surface. To accommodate the irregular surface, each axle 234 of each of the wheel assemblies 208 has been angularly displaced about a horizontal axis passing through the pivot 242 of each axle. Also, the support stem 226 has been angularly displaced relative to the frame 218 just to the point that the support stem 226 makes initial contact with the limit stop 229, i.e. to the point that the support stem 226 makes contact with the frame 218 after being angular displaced a maximum angular displacement. Of note, with the support stem 226 angularly displaced from its initial orientation, the biasing member 282 of the piston centering assembly 270 has been compressed, applying a biasing force upon the support stem 226. However, the biasing force is slight compared to the forces applied by the load to the dolly and has no measurable effect upon the support stem 226. The coupling system 258 permits the support stem 226 to be angularly displaced from its initial orientation relative to the frame 218 while impeding any rotating of the load bearing platform 214 about the predetermined axis.

Referring to FIG. 6, the dolly 202 also includes a retention assembly for selectively retaining the support stem 226 within the cavity 228. The retention assembly includes a pair of stops 292, which in the illustrated embodiment, are a pair of removable fasteners. The stops 292 engage a shoulder 294 of the support stem 226 when the support stem 226 is attempted to be withdrawn from the cavity 228, thereby retaining the support stem 226 within the cavity 228. For instance, often the dolly 202 is moved by lifting the load bearing platform 214, such as by a fork lift. When the dolly 202 is lifted in this manner, the stops 292 engage the shoulder 294, permitting the entire dolly 202 to be lifted via the load bearing platform 214. If the support stem 226 needs to be removed from the cavity 228, such as for maintenance, repair, or replacement, the stops 292 are removed permitting the support stem 226 to be easily lifted from the cavity 228.

While the preferred embodiment of the invention has been illustrated and described, it will be appreciated that various changes can be made therein without departing from the spirit and scope of the invention.

1. A dolly for supporting a load vertically above a horizontal surface and moving the load upon the horizontal surface comprising:
(a) a frame;
(b) a load bearing member for supporting the load, the load bearing member pivotally coupled to the frame; and
(c) a wheel assembly coupled to the frame for permitting the dolly to roll upon the horizontal surface.

2. The dolly of claim 1, further comprising two additional wheel assemblies coupled to the frame for permitting the dolly to roll upon the horizontal surface such that the frame is supported by three wheel assemblies upon the horizontal support surface in a three point suspension manner.

3. The dolly of claim 1, wherein the wheel assembly includes an axle having at least one wheel coupled to the axle, wherein the axle is pivotally coupled to the frame so that the axle may pivot about a substantially horizontally oriented axis and rotatingly coupled to the frame so that the axle may rotate about a substantially vertically oriented axis.

4. The dolly of claim 1, wherein the load bearing member is pivotally coupled to the frame to extend outward from the frame along a selected axis and wherein the load bearing member is coupled to the frame so as to be impeded from rotating about the selected axis.

5. The dolly of claim 1, further comprising a centering assembly coupled to the frame for biasing the load bearing member into alignment with a predetermined axis.

6. The dolly of claim 1, further comprising a limit stop coupled to the frame for impeding the load bearing member from pivoting more than about four degrees from a predetermined axis.

7. The dolly of claim 1, wherein the load bearing member is pivotally coupled to the frame to permit the load bearing member to be angularly displaced in any direction from a predetermined axis while simultaneously being impeded from rotating about the predetermined axis.

8. The dolly of claim 1, wherein the load bearing member is pivotally coupled to the frame by a ball and socket coupling assembly.

9. The dolly of claim 1, wherein the wheel assembly includes an axle having at least one wheel coupled to the axle, and wherein the frame includes a cavity for receiving one end of the load bearing member upon a load bearing surface, wherein an elevation of a lowest point of the load bearing surface from the horizontal support surface is within about six inches or less of an elevation of the axle from the horizontal support surface.

10. The dolly of claim 1, wherein the wheel assembly includes an axle having at least one wheel coupled to the axle, and wherein the frame includes a cavity for receiving one end of the load bearing member upon a load bearing surface, wherein an elevation of a lowest point of the load bearing surface from the horizontal support surface is within about three inches or less of an elevation of the axle from the horizontal support surface.

11. The dolly of claim 1, further comprising a piston coupled to the load bearing member and the frame, wherein the piston is extendable in length to increase a separation distance between the load bearing member and the frame.

12. The dolly of claim 11, wherein the piston includes a fluid line for coupling the piston in fluid communication with another piston associated with another dolly.

13. A dolly for supporting a load above a surface and moving the load upon the surface comprising:
(a) a frame;
(b) a load bearing member for supporting the load, the load bearing member coupled to the frame to have two or more degrees of freedom relative to the frame;
(c) a first wheel assembly coupled to the frame for permitting the dolly to roll upon the surface;
(d) a second wheel assembly coupled to the frame for permitting the dolly to roll upon the surface;
(e) a third wheel assembly coupled to the frame for permitting the dolly to roll upon the surface; and
(f) wherein the first, second, and third wheel assemblies support the frame in a three point suspension above the surface.

14. The dolly of claim 13, wherein the first wheel assembly includes a first axle having at least one wheel coupled to the first axle, wherein the second wheel assembly includes a second axle having at least one wheel coupled to the second axle, wherein the third wheel assembly includes a third axle having at least one wheel coupled to the third axle, wherein the first, second, and third axles are each pivotally coupled to the frame so that each axle may independently pivot about a first axis oriented substantially perpendicular to a length of the axle and wherein the first, second, and third axles are each independently rotatable about a second axis disposed substantially perpendicularly to the first axis.

15. The dolly of claim 13, wherein the load bearing member has three or more degrees of freedom relative to the frame.

16. The dolly of claim 13, further including a biasing member for biasing the load bearing member toward the load and permitting the load bearing member to move relative to the frame so as to change a separation distance between the frame and the load bearing member.

17. The dolly of claim 13, wherein the load bearing member is restricted from rotating about an axis oriented substantially perpendicular to the surface.

18. A dolly for supporting a load vertically above a horizontal surface and moving the load upon the horizontal surface comprising:
(a) a frame;
(b) a load bearing member pivotally coupled to the frame for supporting the load;
(c) a biasing member for moveably supporting the load bearing member relative to the frame and biasing the load bearing member toward the load; and
(d) a wheel assembly coupled to the frame for permitting the dolly to roll upon the horizontal surface.

19. The dolly of claim 18, further comprising three wheel assemblies for suspending the frame above the horizontal surface in a three point suspension.

20. The dolly of claim 19, wherein each of the three wheel assemblies includes an axle independently rotatable about an axis oriented substantially perpendicular to the horizontal surface and pivotably about an axis oriented substantially parallel to the horizontal surface.

21. The dolly of claim 18, wherein the biasing member includes a piston for receiving a fluid under pressure to move the load bearing member toward the load, the piston having a connection for receiving the fluid under pressure from a source located externally of the dolly.

22. The dolly of claim 18, wherein the load bearing member is restricted from rotating about a vertical axis.
